(19) United States
(12) Patent Application Publication
(10) Pub. No.: US 2026/0332089 A1
(43) Pub. Date: Oct. 22, 2026

(54) ULTRA-LIGHTWEIGHT HIGH ENERGY DENSITY RESILIENT SOLAR MODULE SYSTEM WITH ATTACHMENT MECHANISMS FOR RAPID INSTALLATION AND RELOCATION

(71) Applicants: AMIT CHOUDHURY, Toronto (CA); CHASE OLESON, Salinas, CA (US)

(72) Inventors: AMIT CHOUDHURY, Toronto (CA); CHASE OLESON, Salinas, CA (US)

(21) Appl. No.: 19/194,495

(22) Filed: Apr. 30, 2025

Related U.S. Application Data
(63) Continuation-in-part of application No. 18/974,821, filed on Dec. 10, 2024.
Application No. 18/974,821 is a continuation-in-part of application No. 18/138,121, filed on Apr. 23, 2023, now Pat. No. 12,316,270.
(60) Provisional application No. 63/334,660, filed on Apr. 25, 2022.

(51) Int. Cl. H02S 40/34; H02S 20/23; H02S 40/10; H02S 40/36

(52) U.S. Cl. CPC H02S 40/34; H02S 20/23; H02S 40/10; H02S 40/36

(57) ABSTRACT

A solar module system comprises an ultra-lightweight composite substrate with a plurality of internal walls providing structural rigidity, and a plurality of ultra-lightweight solar panels adhesively bonded to the substrate's surface. Each solar panel is constructed with a plurality of solar cells featuring redundant electrical pathways, at least one junction box, a protective ethylene tetrafluoroethylene (ETFE) surface film, and electrical connectors rated at IP67 or higher for waterproofing. The composite substrate includes precisely engineered cutouts aligned with each panel's junction box, ensuring the junction boxes are flush with the substrate's underside. The entire solar module system is designed to maintain an exceptionally low total weight of less than two pounds per square foot, achieving a remarkable balance between structural integrity and lightweight performance.

### CLAIM OF PRIORITY

This application claims priority to U.S. patent application Ser. No. 18/138,121, filed on Apr. 23, 2023, and titled SOLAR AXIS TRACKING SYSTEM FOR PORTABLE CONTAINER UNIT WITH RETRACTABLE PHOTOVOLTAIC SOLAR PANELS. This application is hereby incorporated by reference in its entirety.

U.S. patent application Ser. No. 18/138,121 claims priority to U.S. Provisional Patent Application No. 63/334,660 filed on Apr. 25, 2022. This application is hereby incorporated by reference in its entirety.

U.S. patent application Ser. No. 18/138,121 claims priority to U.S. Provisional Patent Application No. 63/334,128 filed on Apr. 23, 2022. This application is hereby incorporated by reference in its entirety.

### FIELD OF INVENTION

This invention is related to solar energy systems, and more specifically for multiple ultra-lightweight solar panels integrated with a resilient substrate with the ability for variable light transmission and the ability to span large distances using a single solar module system, which can be standalone, joined, attached, embedded or connected using different mechanisms, and rapidly deployed on a roof or wall or as part of a container unit with retractable solar panels, or as a roof or wall, all of which can also be easily and safely relocated and redeployed.

### BACKGROUND

The concept of using a roof, wall or container roof as the supporting structure for traditional glass and metal solar panels has been in the market for more than 20 years.

In almost all cases, the product consists of mounting a solar panel which has a metal frame and a glass surface, which makes them heavy, cumbersome and fragile, onto some form of metal or rigid rack or similar structure, on a rooftop or to create a roof, like in a solar carport, which holds the solar panels in place. To set up the system requires first installing the rack system and then manually mounting the solar panels individually on the rack, usually performed on-site at the physical site where the solar panel will be operational.

Relocating panels so they can be re-used elsewhere takes substantial work effort. Relocation of a solar panel starts with removing a solar panel, requires disassembling each individual solar panel from its rack structure and its rack structure, including the careful electrical disconnection of and subsequent physical removal of the solar panel, and then storing and packing the solar panels for transportation, so the solar panel and its rack can be removed and relocated to a new location. If the glass on the solar panel breaks or the metal frame distorts, during this process, this can risk exposing the solar cells to water and wind causing an electrical short, killing the system and rendering the solar panel useless. The rack may not be reusable in the new location and is discarded.

The rack structure is attached to a rooftop using concrete or other similar heavy weight blocks to create ballast to weigh down the rack and attached solar panel, so they do not fall down or blow away during storms or heavy winds. Often, the rack is set in concrete or equivalent on the rooftop, to permanently affix the solar panels to the roof surface, making it very difficult to detach and remove, with the possibility of damaging the roof, making it challenging to returning the rooftop to its original condition which is the requirement for tenants when leasing a building. This also makes it extremely challenging for tenants to take their solar installation with them at the end of the lease which is almost always shorter than the life of solar panels which is more than 20 years.

In some applications, the solar panels may use a peel and stick method, sometimes referred to as Building-Integrated-Photo-Voltaic (BIPV), of attachment to the roof, wall, container top, or awning surface. Once the adhesive under the panels has cured, it is virtually impossible to separate the panel from the surface, without some extreme removal measure such as using a thermal blanket, or the use of a form of diluted acid. In these cases, the removal process renders the solar panels useless due to micro-fractures in the solar cells or the wiring within the solar panel.

Low-load bearing roofs are pervasive on top of Commercial & Industrial (C&I) buildings such as warehouses, distribution centers, service facilities, light manufacturing & assembly facilities, and older buildings that were never designed to support the weight of heavy traditional solar panels, among others. These roofs are not physically capable of safely supporting the weight and load of traditional solar panels and their rack structures which are heavy and weigh more than three pounds per square foot, often forcing the building owner to make expensive upgrades in engineering, construction and significant structural reinforcement to support the heavier weight.

To avoid creating a dangerous excessive load across the rooftop, some implementations of traditional solar panels on low-load bearing roofs cover just a fraction of the roof, often less than thirty percent (30%) of the roof, spreading out the deployment of the solar over underlying support beams, thereby vastly reducing the amount of energy that can be generated from solar panels located on the rooftop i.e., providing a lower energy density.

During the installation process, each traditional solar panel is attached and installed one at a time on the rack structure, using bolts, screws or clamps, and then each solar panel is connected either to each other in series, or in some cases there is a cable from each solar panel, in parallel, going to a combiner box. Rack structures typically need a physical roof underneath their entire length to support the heavy solar panels on top of them and cannot be floating with an empty space underneath them. This installation process can be tedious, time-consuming and expensive, often requiring people with specialized expertise and certifications, who are a scarce resource.

Traditional solar panels and their rack structures are susceptible to being broken and damaged during storms from wind, water, vibration, impact from debris and hail due to their limited resiliency to inclement weather.

To span distances larger than the length or width of a typical solar panel (e.g., a span of 10 feet or even as large as 40 to 50 feet, etc.), as seen in solar car ports, first requires a separate physical substantial bridge-like structure or truss, to span the distance, usually made of metal with multiple structural support pillars placed into the ground underneath or a cantilever or suspension design, fully supporting the entire length of the span, upon the top of which the heavy solar panels can be subsequently mounted.

To prevent water evaporation from water canals and water reservoirs and also provide the cooling effect by providing shade for wastewater treatment plant bio-organisms, there are few structural options to cover the large airspace above them, while also safely generating energy.

When light transmission below the solar panels is a requirement, such as in green house rooftops, or over open water reservoirs to support micro-organisms in the water, most rack mount solar or floating pontoon structures are not contiguous and achieve this by just creating gaps of empty airspace to allow light in, in addition to potentially other unwanted material such as debris.

When there is a need to ensure a solar panel does not create an electric short or become a potential electric hazard, traditional panels are not encapsulated, and therefore attempt to stay above water, attempting to prevent from being submerged, and are mounted on floating pontoons.

### BRIEF SUMMARY OF THE INVENTION

In one aspect, a solar module system comprises an ultra-lightweight composite substrate with a plurality of internal walls providing structural rigidity, and a plurality of ultra-lightweight solar panels adhesively bonded to the substrate's surface. Each solar panel is constructed with a plurality of solar cells featuring redundant electrical pathways, at least one junction box, a protective ethylene tetrafluoroethylene (ETFE) surface film, and electrical connectors rated at IP67 or higher for waterproofing. The composite substrate includes precisely engineered cutouts aligned with each panel's junction box, ensuring the junction boxes are flush with the substrate's underside. The entire solar module system is designed to maintain an exceptionally low total weight of less than two pounds per square foot, achieving a remarkable balance between structural integrity and lightweight performance.

### BRIEF DESCRIPTION OF THE DRAWINGS

The present application can be best understood by reference to the following description taken in conjunction with the accompanying figures, in which like parts may be referred to by like numerals.

FIG. 1 illustrates an example set of the ultra-lightweight solar module systems, according to some embodiments.

FIG. 2 illustrates an example assembly process for a solar-module, according to some embodiments.

FIG. 3 illustrates an example encapsulation process for encapsulating and implementing a rigid ultra-lightweight high energy density, resilient solar module system, according to some embodiments.

FIG. 4 illustrates a logical view of an ultra-lightweight solar module system, according to some embodiments.

FIG. 5 illustrates an example section view, according to some embodiments.

The Figures described above are a representative set and are not an exhaustive set with respect to embodying the invention.

### DESCRIPTION

Disclosed are a system, method and article of manufacture of an ultra-lightweight solar module system, with integrated solar panels, composite substrate, connectors and fasteners for rapid installation and removal for relocation. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principals defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Example Definitions

Photovoltaic cells are a specialized semiconductor device designed to convert light energy directly into electrical energy through the photovoltaic effect. When photons from sunlight strike the cell's surface, they excite electrons within the semiconductor material, typically made of silicon, causing them to break free from their atomic bonds and generate an electric current. The photovoltaic cell can be constructed with layers of specially treated semiconductor materials, usually involving a positively charged and a negatively charged layer, which can create an electric field that facilitates the movement of these excited electrons and generates a usable electrical potential.

Thin ethylene tetrafluoroethylene (ETFE) surface film is a transparent, flexible, and highly durable fluoropolymer material that is increasingly used as an alternative to glass in solar applications and architecture. In some examples, a ^{~}100 microns thin, ETFE film provides excellent light transmission while being about 1% the weight of traditional glass, making it ideal for lightweight construction and solar panel protection. The material exhibits remarkable resistance to UV radiation, extreme temperatures, and chemical corrosion, with a lifespan that can exceed 25 years in outdoor applications. ETFE film also demonstrates self-cleaning properties due to its non-stick surface, requires minimal maintenance, and can withstand significant structural loads despite its minimal thickness.

Using the term “ultra-lightweight” because this is truly unique, to the best of our knowledge. Could add the term “rigid”, because there are solar panels that come in rolls which are also ultra-lightweight, but these are “thin-film” (e.g., First Solar) technology and not mono or poly silicate or perovskite cells. Although our marketing brand name for this is CITADEL (because the solar module system has the strength and resiliency of a fortress), in this document, I have referred to the device as a generic sounding name i.e., Ultra-Lightweight Solar Module System which contains multiple solar panels, thereby using the term “module” to differentiate from the word “panel”.

### Example System

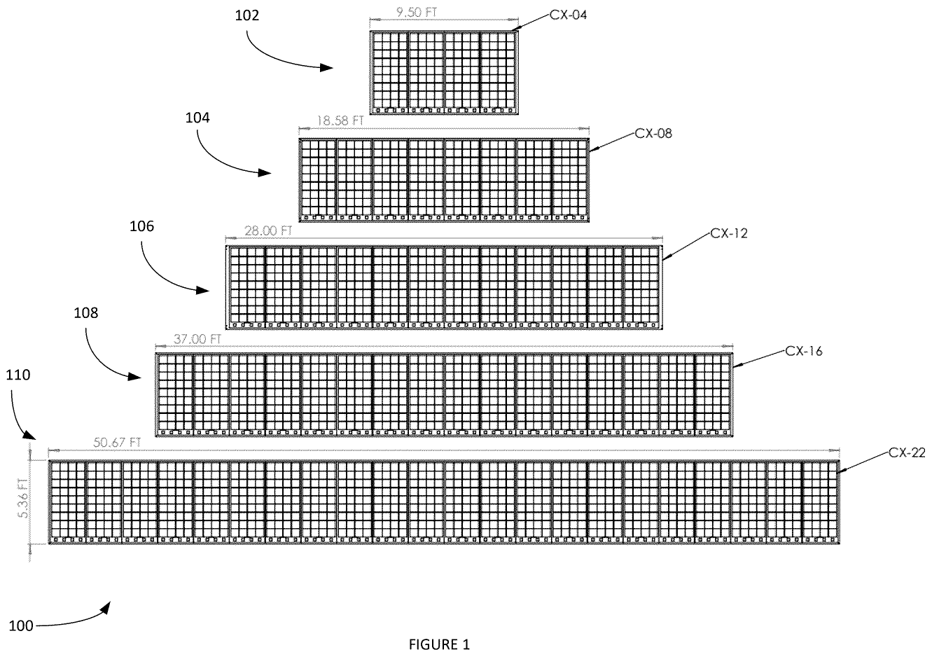

FIG. 1 illustrates an example set of the ultra-lightweight solar module systems 100, according to some embodiments. By way of example, these are shown as ~10-foot (ft.) version 102, ~20 ft. version 104, ~30 ft. version 106, ~40 ft. version 108 and ~51 ft. version 110 versions. It is noted that these are provided by way of example and not of limitation.

The primary components of the ultra-lightweight solar module system 100 can be an ultra-lightweight fluted composite polycarbonate substrate (e.g. ultra-lightweight fluted composite substrate 402) which has multiple walls (multiwall polycarbonate) within its structure to provide rigidity and strength, and weighs about half a pound per square foot, and the ultra-lightweight solar panels (e.g. solar panels 404) which weigh less than one pound per square foot including the additional layer of evenly applied very high bond adhesive across the underside of each panel used to integrate the solar panel and substrate.

In some examples, it is noted that the ultra-lightweight fluted composite substrate is a polycarbonate material and can have as little as two walls and be four millimeters (4 mm) thick and weigh less than 0.18 PSF, or have five walls, inside the structure thereby providing the rigidity and durability, and still be only sixteen millimeters (16 mm) thick and weigh less than 0.55 PSF, or as many as eleven walls inside the structure thereby preventing any bend, and be as thick as forty millimeters (40 mm) and weigh less than 0.80 PSF.

The ultra-lightweight fluted composite substrate maintains significant rigidity along the long axis, which has a low bend radius, or can be a no bend radius, providing the strength suitable for applications requiring long spans. In some embodiments, the bend radius for the current substrate is 138 inches, which is more than eleven (11) feet. It has a minimum thickness of sixteen millimeters (16 mm) which allows junction boxes, related cables and the multi-contact connectors to sit flush within the substrate.

The ultra-lightweight fluted composite substrate is designed to be water-resistant, ensuring durability in various environmental conditions and is resilient to high storm winds and water, vibration caused by storms, impact from debris and hail, and large temperature swings.

The composite substrate material of the ultra-lightweight fluted composite substrate includes additives in the manufacturing process rather than applied as a coating afterward, which provides extra UV resistance. This inclusion in the manufacturing process ensures long-lasting protection against UV degradation.

The ultra-lightweight fluted composite substrate includes additives in the manufacturing process which impacts the percentage of visible light transmission possible through the substrate which can be from zero to 65 percent (65%).

The system incorporates multiple ultra-lightweight solar panels physical set upon and adhered using peel and stick technology to the common substrate and connected using cabling and multi-connectors in a combination of series and/or parallel connections all within the manufacturing process of the ultra-lightweight solar module system.

Each solar panel attached to the ultra-lightweight fluted composite substrate weighs less than one pound per square foot, including the layer of very high bond adhesive. These solar panels are very durable and resilient to various environmental conditions such as high storm winds and water, vibration caused by storms, impact from debris and hail, and large temperature swings.

The cells within each solar panel (e.g. photovoltaic cells 406) have redundant electrical pathways capable of dynamically auto-rerouting energy to ensure power generation, even if an individual cell is damaged or shaded. Each solar panel has one or more integrated bypass diodes to provide the most efficient output of power even under extreme conditions. This redundancy architecture is extended across the entire ultra-lightweight solar module system.

Each solar panel is equipped with one or more junction boxes, which can be approximately sixteen millimeters (16 mm) tall in some example embodiments. The junction boxes (e.g. junction boxes 408) can be placed where needed but typically protrude below the back of the solar panels, necessitating cutouts in the ultra-lightweight fluted composite substrate to support a flush mounting.

These cutouts are made using devices such as a routing table or heated press in large-scale manufacturing. The cutouts are designed to only remove enough material to accommodate the junction boxes, ensuring a sealed and flush surface on the bottom of the solar module system. This design enhances water resistance, protects and allows for cleaner cable and connector management.

The junction boxes and cables and multi-connectors (e.g. interconnective cabling 412) that connect each of the solar panels within the solar module system are effectively embedded through the substrate becoming flush with the underside of the substrate. In effect, the junction box, cables and multi-connectors are held within the composite substrate during the manufacturing process at the factory, thereby streamlining and simplifying connectivity within the solar module system, and reducing on-site installation down to minutes, compared to the hours it takes if this work was to be completed on-site.

In some examples, the ultra-lightweight solar module system 100 is built in the factory and pre-wired to act as a “single” module. This can be analogous to pre-fab homes being built in factories and deployed on-site. Currently, no one builds solar arrays acting as a “single” module in a pre-fab mode and then deploys them.

The ultra-lightweight fluted composite substrate uses precise cutouts for junction boxes, cabling and multi-connectors so the solar panels can sit flush on the top side of the substrate. The cutouts in the ultra-lightweight fluted composite substrate serve as a mechanism to lock the panels into alignment and also ensure they lie flat on its surface, which helps make the entire solar module system resilient to high storm winds and water, vibration caused by storms, impact from debris and hail, and large temperature swings. For example, if a bullet penetrates a cell in a solar panel, only the area damaged by the bullet will provide no power generation, while the rest of the cell, panel and the remainder of the solar module system can continue to function.

The ultra-lightweight solar module system 100 offers significant advantages in terms of reduced packaging, transportation weight and space, assembly time and installation equipment required on-site, and provides enhanced resiliency and durability. This is a substantial improvement over traditional glass and metal solar panels for commercial and industrial rooftop, container top and ground mount applications. The ultra-lightweight solar module system 100 can also be used in residential rooftop applications.

The ultra-lightweight solar module system 100 can be suitable for various applications, from rooftop implementations as well as a primary roofing material for commercial and industrial buildings, as well as structures such as solar carports, solar canal covers, water reservoir solar covers, wastewater treatment facility solar covers, solar walls and solar fences, especially when you want to use a single solar module system to cover the entire span.

The ultra-lightweight solar module system's modular design supports scalability, accommodating different power requirements and installation sizes. The ultra-lightweight solar module system 100 can be connected to each other to provide both energy scalability as well as span scalability.

The ultra-lightweight design of the ultra-lightweight solar module system 100 dramatically reduces the structural support requirements and any need for significant structural reinforcement of rooftops, making it easier to design, engineer and much faster to build for a wide range of applications.

The ultra-lightweight solar module system 100 is sufficiently strong and rigid enough it can also be used as the primary roofing material for commercial and industrial buildings, as well as for some wall and fence structures.

When used on top of low-load bearing rooftops, such as those in commercial and industrial buildings, the ultra-lightweight solar module system 100 which weighs about one and half pounds per square foot (PSF) can be placed over the entire rooftop without risking collapse of the roof due to the amount of weight being placed on the rooftop. When used in applications such as solar carports, the solar module system provides shading and lowers the temperature underneath.

When used as solar canal covers, water reservoir covers, and wastewater treatment facilities, the ultra-lightweight solar module system prevents evaporation, as well as shading to lower the temperature underneath for living organisms, while also providing protection from inclement weather.

The ultra-lightweight solar module system 100 offers configurations that range from 720-Watt systems which are 10-feet long and up to 3960-Watt which are 51-feet in length, per ultra-lightweight solar module system 100, far in excess of traditional glass and metal solar panels which currently reach a maximum of about 700 Watts.

The physical span of the ultra-lightweight solar module system 100 can be much longer than 51-feet and can be stretched up to several hundred feet during the manufacturing process, and therefore support even higher wattages per ultra-lightweight solar module system. Consideration should be given as to how these systems are going to be physically transported to their physical site, and any voltage limits typically less than 1500V, or as specified by the National Electrical Code (NEC) to ensure safe electrical operating conditions.

The ultra-lightweight solar module system provides scalable solar energy solutions that are easy to install, and due to their encapsulation and resilience, are easy to maintain. By minimizing the need for extensive, expensive racking systems and the installation of one individual panel at a time, the system streamlines the installation and setup process, while simultaneously reducing labor costs. The ultra-lightweight solar module system 100 uses fasteners which support rapid installation and removal.

Overall, the ultra-lightweight solar module system presents a significant advancement in deploying solar energy technology. It provides an ultra-lightweight, resilient, high-energy density, scalable solution for rapid installation and re-deployment of solar energy across a wide range of applications.

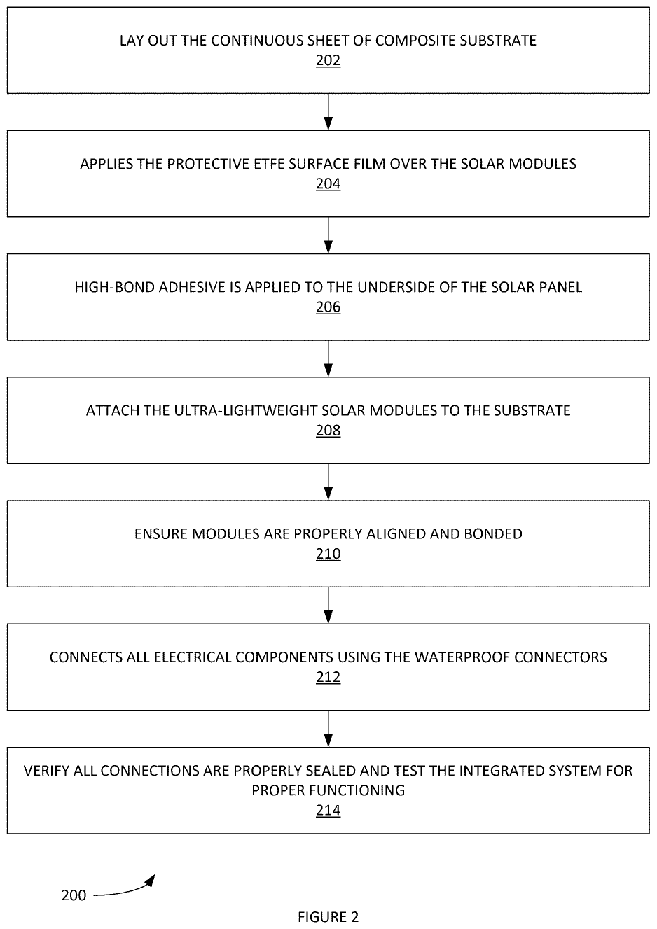

FIG. 2 illustrates an example assembly process 200 for a solar-module, according to some embodiments. Starting components begin with multiple ultra-lightweight solar modules. Prepare a continuous sheet of ultra-lightweight composite substrate. Process 200 can ensure availability of very high bond adhesive (made from acrylic polymer or butyl adhesive). Process 200 can have ETFE surface film (100 microns thin) ready for protection. Prepare IP67/IP68-rated multi-contact connectors for waterproofing.

Assembly process 200 can first lay out the continuous sheet of composite substrate in step 202. In step 204, assembly process 200 applies the protective ETFE surface film over the solar modules. It is noted that cutouts can be utilized. The ETFE surface can be applied at the OEM solar provider's facility.

In step 206, a very high-bond adhesive is applied to the underside of the solar panel. This is done by an OEM manufacturer of the solar panel to create a peel and stick surface.

In step 208, assembly process 200 attaches the ultra-lightweight solar modules to the substrate (e.g. using a “peel and stick” method, etc.). Process 200 can attach the ultra-lightweight solar module to the substrate (e.g. which has specific cut outs using very precise routing tables where the junction boxes and associated wiring can fit inside).

In step 210, assembly process 200 ensures modules are properly aligned and bonded. For example, process 200 can ensure modules are properly aligned and bonded with the junction box(es) and connecting wires embedded inside the substrate so they can be connected to modules on either side in series, or with modules on either side in parallel, such that the entire solar module system acts as one electrically connected module system.

Process 200 can install the waterproof multi-contact connectors. In step 212, assembly process 200 connects all electrical components using the waterproof connectors. In step 214, process 200 connects all electrical components using the waterproof connectors, verifies all connections are properly sealed, and tests the integrated system for proper functioning.

Assembly process 200 can also prepare for transportation if needed (e.g. solar-module system can be transported in a 53-ft container). The assembled solar-module system that is 51 ft in length, can generate up to 3,960 watts of power. An assembled solar-module system can extend to 400+ feet in length. The assembled solar-module system can have an energy density 2-4 times higher or more than traditional solar panels. The assembled solar-module system maintains flexibility for rapid installation and relocation. The design of the assembled solar-module system can ensure durability and UV resistance through composite substrate. It is further noted that waterproofing is maintained through specialized connectors.

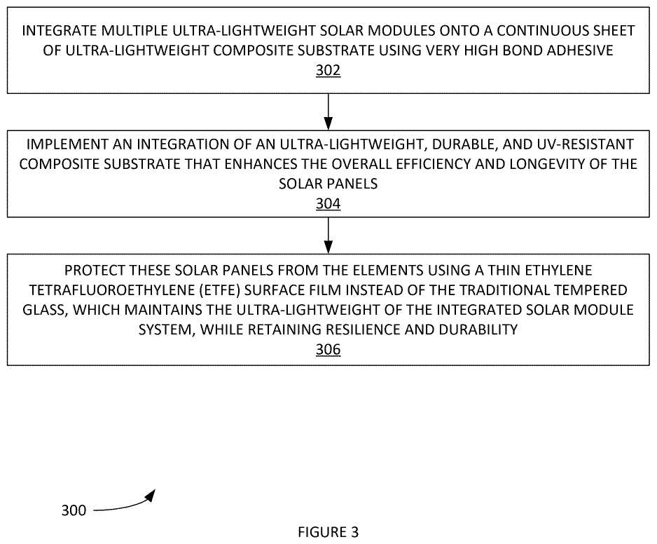

FIG. 3 illustrates an example encapsulation process 300 for implementing a rigid ultra-lightweight high energy density, resilient solar module system, according to some embodiments. Process 300 provides an innovative solution for solar energy systems through a rigid ultra-lightweight high energy density, resilient solar module system which can be rapidly installed and relocated when needed. Process 300 integrates multiple ultra-lightweight solar modules onto a continuous sheet of ultra-lightweight composite substrate using very high bond adhesive in step 302. In this way, they function as a single ultra-lightweight solar module system of varying lengths, with a range of high energy density far in excess of existing solar panels. For example, two to four times the amount of energy production of traditional solar panels. By way of example, ultra-lightweight solar module system can be as much as 3,960 watts and still be transported inside a 53-ft container. In some examples, the length of the ultra-lightweight solar module system could be as much as 400+ feet and is only really restricted by the size of the manufacturing building and how to transport it to the physical site.

In step 304, process 300 implements an integration of an ultra-lightweight, durable, and UV-resistant composite substrate that enhances the overall efficiency and longevity of the solar panels. The solar panels themselves are encapsulated, resilient, peel and stick, and attach to the substrate using a very high bond adhesive. A very high bond adhesive can be made from an acrylic polymer material and/or a butyl adhesive and can be designed for applications to create a permanent bond.

In step 306, process 300 protects these solar panels from the elements using a thin ethylene tetrafluoroethylene (ETFE) surface film instead of the traditional tempered glass, which maintains the ultra-lightweight of the integrated solar module system, while retaining resilience and durability. It is noted that the ETFE layer can be 100 microns thin in some examples. The system supports waterproofing by using multi-contact connectors which are rated at IP67 or IP68, thereby reducing the possibility of electrical short circuits.

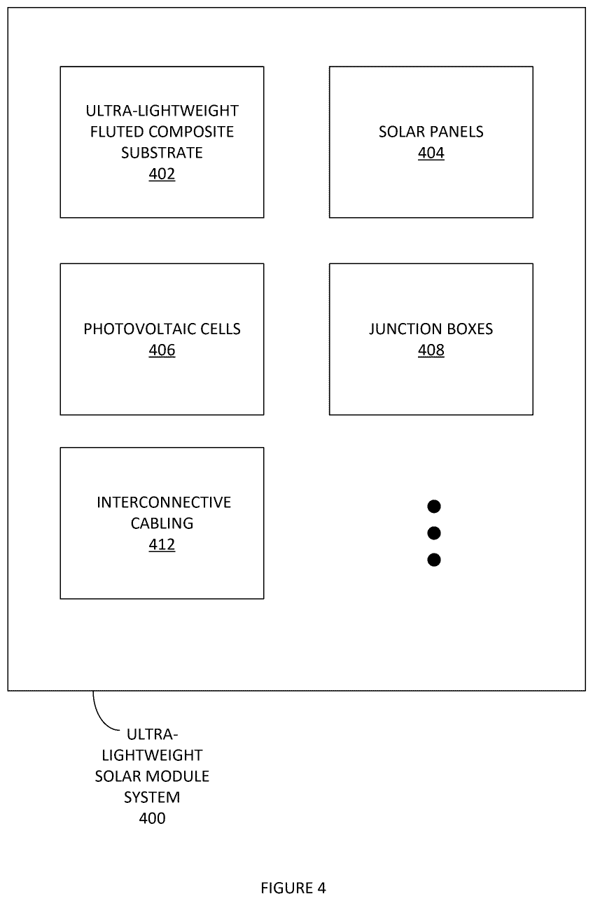

FIG. 4 illustrates a logical view of an ultra-lightweight solar module system 400, according to some embodiments. Ultra-lightweight solar module system 400 can be used to implement ultra-lightweight solar module system 100. The ultra-lightweight solar module system 400 demonstrates an innovative architectural design for solar energy harvesting, leveraging advanced materials and integration techniques. The ultra-lightweight fluted composite substrate 402 incorporates a multi-walled structural configuration, optimizing the strength-to-mass ratio with a nominal surface density of approximately 0.5 lb./ft².

The solar panels 404 exhibit exceptional mass efficiency, with a comprehensive panel assembly weighing less than 1 lb./ft², including a precisely engineered very high-bond adhesive layer that provides uniform substrate integration. The adhesive layer is strategically applied to maximize structural cohesion and minimize mass overhead.

The photovoltaic cells 406 are engineered with a sophisticated fault-tolerant electrical architecture, implementing redundant power transmission pathways. This design enables dynamic electrical route reconfiguration, ensuring continued power generation under partial obstruction or localized cell degradation scenarios.

Junction boxes 408 are strategically positioned, typically interfacing with the posterior surface of the solar panels. The substrate 402 incorporates precision-engineered cutout geometries to facilitate flush-mounted junction box integration, minimizing structural discontinuities and aerodynamic protrusions.

The system's junction boxes 408, interconnective cabling 410, and multi-connector assemblies are comprehensively embedded within the composite substrate during the manufacturing process. This integrated approach eliminates on-site assembly complexities, reducing installation time from conventional multi-hour deployment protocols to a matter of minutes, thereby significantly enhancing system deployability and operational efficiency.

Some example use cases are now discussed by way of six use cases. On a low-load bearing rooftop, ultra-lightweight solar module systems 100 can be on regular rooftops as well. Ultra-lightweight solar module systems 100 can be installed on top of a container as these are a precise ultra-lightweight solar module system. Ultra-lightweight solar module systems 100 can be installed on support pillars for solar car ports, canal covers, water reservoirs, and wastewater treatment plants. Ultra-lightweight solar module systems 100 can be installed on walls, typically vertically oriented, because the solar modules can pick up scattered/diffused light and perform significantly better than traditional solar panels in this orientation (e.g. but still less than the 90-degree angle of incidence). It does however use otherwise empty space. Ultra-lightweight solar module systems 100 can be installed on the ground, using a typical ground mount rack, but due to their ultra-lightweight, the racks do not need to be as robust, just securely placed into the ground. Ultra-lightweight solar module systems 100 can be installed on and/or used as an actual roof or wall itself (e.g. as “Solar Walls” and “Solar Fences”, etc.).

The manufacturing process for this solar module system employs a sophisticated continuous production line with multiple precise stages. The process begins by fabricating the composite substrate through an extrusion method, during which UV-resistant and light transmission additives are integrated directly into the polycarbonate material. Precise cutouts for junction boxes are then created using advanced CNC routing or heated press operations. Solar panels undergo a separate preparation process, involving ETFE lamination and application of a very high bond adhesive. During assembly, panels are meticulously aligned and bonded to the substrate, with electrical integration of junction boxes and connectors accomplished through the precisely created cutouts. Rigorous quality control measures include comprehensive electrical testing of redundant pathways and verification of waterproof sealing. Before packaging and transport, the entire system is pre-wired and tested as a single, integrated unit. Throughout the manufacturing process, strict control of temperature and humidity is maintained to optimize adhesive bonding and ensure consistently high-quality production.

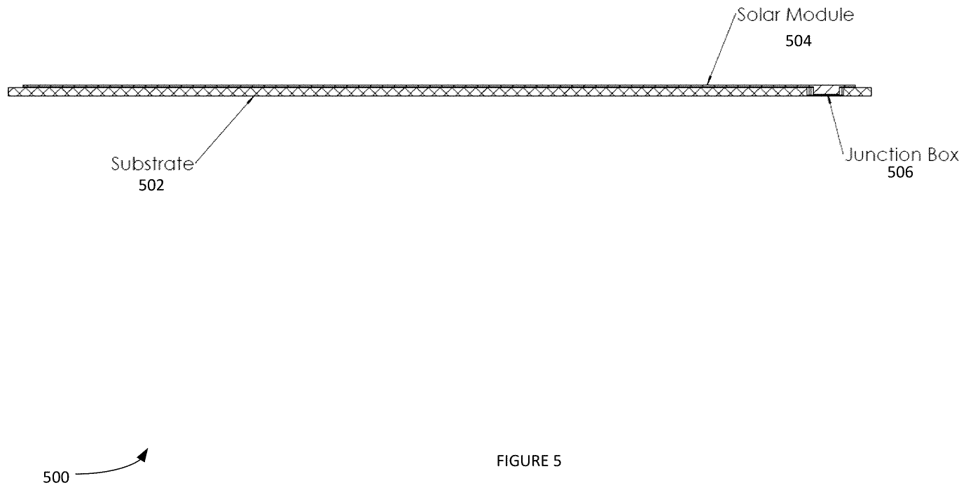

FIG. 5 illustrates an example section view 500, according to some embodiments. Section view 500 figure provides a detailed cross-sectional illustration of the CITADEL solar module system. Section view 500 reveals the layered construction that forms the core of the invention.

Section view 500 shows the relationship between three primary components of the system: the solar module 504 (positioned at the top), the junction box 564 (in the middle), and the substrate 502 (at the bottom). As shown, the solar module 504 can be mounted directly on top of the substrate, which aligns with the patent's description of using a high-bond adhesive to attach the ultra-lightweight solar panels to the composite substrate.

The junction box 506 is shown embedded within the substrate, rather than protruding from the bottom. As shown, precise cutouts are made in the substrate to accommodate the junction boxes, allowing them to sit flush with the underside of the substrate. This flush mounting enhances the water resistance of the system and creates a cleaner installation with better cable management.

The substrate 502 can have a structured internal configuration of multiple walls that provide rigidity and strength while maintaining the ultra-lightweight characteristics. FIG. 5 demonstrates how the three components are integrated into a cohesive unit that functions as a single solar module system, supporting the patent's claims about factory assembly and simplified on-site installation.

Various example embodiments are now discussed. The solar panels discussed supra can be encapsulated, and the combined solar module system can also be treated as if encapsulated. In other words, it could operate 1-inch (by way of example) below the water's surface. This can be used to increase energy production for two reasons, inter alia: water magnifies the solar irradiation and increases energy production; and water underneath cools the solar module, which also serves to increase energy production.

It is noted that systems and methods provided herein can be used to create a 10,880 W module system which can be approximately 142 ft in length and under or equal to 1,500 V limit. However, in other examples, the limit could be increased to 2,000V, which would be an approximately 200 ft module with 15,120 W.

The ultra-lightweight fluted composite substrate can be engineered with varying structural configurations to accommodate specific installation requirements and load-bearing capacities. By way of example, in some embodiments, substrates can range from simple 2-wall structures (e.g. 4-10 mm thickness) with bend radii as small as 30 inches and weighing only 0.164-0.348 lb/ft², to more complex structures such as a 5-wall reversible double coating (RDC) which provides dual-sided UV protection, an extended lifespan and weather resistance, configuration with a 138-inch bend radius at 0.522 lb./ft², to highly rigid 11-wall structures (32 mm thickness) designed not to bend at all while still maintaining a relatively light weight of 0.758 lb./ft². These ranges are provided by way of example and not by limitation. The use of these modules enables optimal selection based on the various application contexts (e.g. such as those discussed supra). These can include, inter alia: flexible configurations for curved installations, slight-bend options for moderate spans, and no-bend variants for maximum structural integrity across extended distances. The resiliency or durability of the integrated solar module system is exceptional, being likely the only such system which can withstand wind speeds of Category 4 and Category 5 hurricanes, as well as direct impact from hail and debris. Each configuration maintains the system's ultra-lightweight characteristics while providing appropriate structural support for the adhered solar panels, with the specific substrate selection determining the final installation profile and performance characteristics.

What is claimed by United States patent:

1. A solar module system comprising:
an ultra-lightweight composite substrate having a plurality of internal walls providing structural rigidity;
a plurality of ultra-lightweight solar panels adhesively bonded to a surface of the composite substrate;
wherein each solar panel comprises:
a plurality of solar cells with redundant electrical pathways;
at least one junction box;
a protective ethylene tetrafluoroethylene (ETFE) surface film;
electrical connectors rated at IP67 or higher for waterproofing;
wherein the composite substrate comprises cutouts aligned with the at least one junction box of each solar panel such that the junction boxes are flush with an underside of the substrate; and
wherein the solar module system has a total weight of less than two pounds per square foot.

2. The solar module system of claim 1, wherein the composite substrate comprises polycarbonate material having between two external walls and as many as nine internal plus two external walls for a total of eleven walls.

3. The solar module system of claim 2, wherein the composite substrate has a thickness of as little as four millimeters, often approximately sixteen millimeters but could be as much as 40 millimeters.

4. The solar module system of claim 3, wherein the composite substrate includes manufactured-in additives providing UV resistance.

5. The solar module system of claim 4, wherein the composite substrate includes manufactured-in additives enabling variable light transmission between zero and sixty-five percent.

6. The solar module system of claim 5, wherein the plurality of solar panels is adhesively bonded using a very high bond adhesive comprising at least one of an acrylic polymer material or a butyl adhesive.

7. The solar module system of claim 6, wherein the protective ETFE surface film has a thickness of approximately 100 microns.

8. The solar module system of claim 7, wherein the electrical connectors comprise multi-contact connectors configured in a combination of series and parallel connections.

9. The solar module system of claim 8, wherein each solar panel comprises one or multiple integrated bypass diodes.

10. The solar module system of claim 9, wherein the system has a length between 10 feet and 400 feet.

11. The solar module system of claim 10, wherein the system generates between 720 watts and 3960 watts of power.

12. The solar module system of claim 11, wherein the redundant electrical pathways enable dynamic auto-rerouting of energy to ensure power generation even if an individual cell is damaged or shaded.

13. The solar module system of claim 12, further comprising a continuous protective layer that maintains the system's water resistance and durability under environmental conditions including high storm winds, water, vibration, debris impact, and temperature variations.

14. The solar module system of claim 13, wherein the junction boxes, cables, and multi-contact connectors are embedded within the composite substrate during manufacturing, creating a flush-mounted, integrated electrical connection system.

15. The solar module system of claim 14, wherein the solar panels are installed on multiple surface types comprising rooftops, containers, support pillars, walls, ground mounts, integral roofing or wall structures.
